(19) United States
(12) Patent Application Publication
(10) Pub. No.: US 2013/0252129 A1
(43) Pub. Date: Sep. 26, 2013

(54) System, Method and Device for Use of a Carbonaceous Material as a Fuel for the Direct Generation of Electrical and Thermal Energy

(71) Applicant: Andrew Parfitt, Silver Spring, MD (US)

(72) Inventor: Andrew Parfitt, Silver Spring, MD (US)

(21) Appl. No.: 13/796,071

(22) Filed: Mar. 12, 2013

Related U.S. Application Data
(60) Provisional application No. 61/615,718, filed on Mar. 26, 2012.

(51) Int. Cl. H01M 8/10; C02F 1/02

(52) U.S. Cl. CPC H01M 8/1004; C02F 1/02
USPC 429/482; 429/401; 205/746

(57) ABSTRACT

A solid oxide supercritical water electrochemical cell which uses carbonaceous materials, such as sewage or waste food, in a mixture with fluid as fuel, simultaneously generating two or more forms of energy by means of combustion of oxidizable carbonaceous material in whole or in part by electrochemical oxidation under hydrothermal conditions.

### CROSS REFERENCE TO RELATED APPLICATION(S)

This application claims the benefit of U.S. Provisional Patent Application Ser. No. 61/615,718 filed Mar. 26, 2012, the entire disclosure of which is incorporated herein by reference.

### BACKGROUND

1. Field of the Invention

This disclosure is related to the general field of systems and devices used for the production of useable energy from any oxidizable material and for the disposal of and the recovery of energy from human waste products, such as fecal sludge and food waste, to achieve a safe and affordable sewage treatment and disposal system.

2. Description of Related Art

About 2.6 billion people—40 percent of the world's population—use unsanitary toilets or practice open defecation. In fact, the conventional sanitation systems commonly utilized in the developed world—a flush toilet connected to a centralized sewer system—is possible for only a small fraction of people in developing nations. Historically, people and cultures have rejected sanitation solutions offered by governments, donors, and non-governmental organizations because the offered solutions require an infrastructure that is untenable, too expensive, inconvenient to use or unpleasant to maintain. For example, traditionally, providing safe, effective sanitation services to the poor has focused on the construction of freestanding latrines through government-sponsored programs, with little input from the community and little regard for what users really wanted and needed. In the implemented on-site systems, such as pit latrines, waste does not decompose fast enough or completely leading the pits to fill up, causing flies, odors and unpleasant conditions. Because replacing or emptying full pits is difficult and expensive, once these latrines are installed, they are often not used or maintained.

The direct consequences of the unsafe sanitation systems commonly utilized in many parts of the world can be devastating and last a lifetime. For example, fecal-oral contamination is an underlying factor in more than 50 percent of child deaths in the developing world. Further, every year, food and water tainted with fecal matter cause up to 2.5 billion cases of diarrhea among children. These cases of chronic diarrhea in children can hinder child development by impeding the uptake of essential nutrients that are critical to the development of a child's immune system, mind and body. Tellingly, chronic diarrhea results in 1.5 million child deaths each year.

The impact of the implementation of sanitary waste management systems within a culture and a society are nothing short of monumental. No public health intervention in the past 200 years has done more to save lives and improve health in the world's wealthy nations. For example, improved sanitation can reduce child diarrhea by 40 percent. Improved sanitation can also have an economic benefit, potentially producing $9 for every dollar invested by increasing productivity, reducing healthcare costs, and preventing illness, disability and early death. In addition, to the health and economic benefits, access to clean, safe and convenient sanitation systems provides greater dignity, privacy and security to individuals and societies.

Notably, the developing areas of the world which lack sanitary waste management systems also often lack reliable energy grids and sources of energy. Similar to the reasons behind the lack of sanitation infrastructure, these cultures and societies lack the resources and capital to create the infrastructure necessary to support the creation and distribution of energy.

Notably, carbonaceous materials commonly created by individuals and societies, such as food waste and fecal matter, contain large amounts of energy. For example, though it is lower in energy than the food it came from, human feces may still contain a large amount of energy, often about 50% that of the original food. A system and device which could recovery energy and potable water from carbonaceous materials such as fecal sludge, offering a safe affordable treatment and disposal system for human sewage, could solve both the sanitation and energy problems that confront these communities.

Accordingly, there is a potent need for innovations in sanitation tools and technologies that are affordable, safe and centered on the needs of the user, that have the capability of recovering energy from carbonaceous materials such as fecal sludge, and that can provide safe and sanitary disposal systems.

### SUMMARY

Because of these and other problems in the art, described herein, among other things, is a compact, stand-alone device that uses a non-microbial system of progressive reactor modules to mineralize carbonaceous materials such as sewage, food waste and other biomass and simultaneously generate electrical power which could be used in any location to provide sanitation and purified water for a potable water supply.

There is described herein, among other things, a solid oxide supercritical water electrochemical cell comprised of: a reactive species chamber with an intake portal and an outtake portal, the reactive species chamber including an oxidant; a fuel chamber with an intake portal and an outtake portal, the fuel chamber including an oxidizable material and supercritical water; and a multifunctional membrane complex which separates the reactive species chamber from the fuel chamber, the multifunctional membrane complex being comprised of: an electron conductor; an electrolyte; a cathode; and an anode; wherein, the oxidant contacts the cathode and produces oxygen ions which flow from the cathode, through the electrolyte, to the anode; and wherein the oxygen ions reacting with the oxidizable material at the anode to produce free electrons.

In an embodiment of the cell, the oxidizable material is dissolved or suspended in the supercritical water.

In an embodiment of the cell, the oxidant in the reactive species chamber is a gas at or near its normal atmospheric pressure from which oxygen ions can be generated through a reduction reaction.

In an embodiment of the cell, the gas is air.

In an embodiment of the cell, the oxidant is oxygen.

In an embodiment of the cell, the oxidizable material is a biomass.

In an embodiment of the cell, the biomass is chosen from the group consisting of: human fecal matter and sewage solids.

In an embodiment of the cell, the oxidizable material is at a pressure that is equal to or less than about 80 megapascals (MPa).

In an embodiment of the cell, the oxidizable material is at a temperature of equal to or less than about 800° C.

In an embodiment of the cell, the cathode is comprised of a material chosen from the group consisting of: lanthanum manganite, lanthanum ferrite and lanthanum coboltite.

In an embodiment of the cell, the electrolyte is comprised of a material chosen from the group consisting of: doped cerium oxide and doped yttrium oxide.

In an embodiment of the cell, the anode is comprised of a material chosen from the group consisting of: Ni-YSZ composite and Cu-cerium oxide.

In an embodiment of the cell, the solid oxide supercritical water electrochemical cell is configured a planar orientation.

In an embodiment of the cell, the solid oxide supercritical water electrochemical cell is configured in a tubular orientation.

In an embodiment of the cell, the reactive species chamber comprises a longitudinal cylindrical channel defined by the multifunctional membrane complex, the multifunctional membrane complex comprising a cylindrical cathode layer; a cylindrical electrolyte layer; and a cylindrical anode layer, wherein the cylindrical cathode layer is in intimate contact with the cylindrical reactive species chamber; wherein the cylindrical electrolyte layer is located between the cylindrical cathode layer and the cylindrical anode layer; and the reactive species chamber and the multifunctional membrane complex are located within the fuel chamber.

In an embodiment of the cell, the oxidant flows into the cylindrical reactive species chamber at one end and the depleted air flows out of the cylindrical reactive species chamber at the other end.

In an embodiment of the cell, the cylindrical reactive species chamber includes a heating element.

There is also described herein a method for purifying water, the method comprising: providing a solid oxide supercritical water electrochemical cell including: a reactive species chamber with an intake portal and an outtake portal; a fuel chamber with an intake portal and an outtake portal; and a multifunctional membrane complex which separates the reactive species chamber from the fuel chamber, the multifunctional membrane complex being comprised of: an electron conductor; an electrolyte; a cathode; and an anode; feeding air into the reactive species chamber via the intake portal; feeding an oxidizable material and water into the fuel chamber; raising the water in the fuel chamber to supercritical temperature and pressure; allowing oxygen ions to flow from the reactive species chamber, through the multifunctional membrane complex, to the fuel chamber; allowing the oxygen ions to react with the oxidizable material generating free electrons; capturing the free electrons with the electron conductor; and removing clean water from the fuel chamber.

In an embodiment of the method, the oxidizable material is a biomass.

In an embodiment of the method, the biomass is chosen from the group consisting of: human fecal matter and sewage solids.

### BRIEF DESCRIPTION OF THE DRAWINGS

FIG. 1 provides a block diagram of an embodiment of the solid oxide-supercritical water electrochemical cell in a planar configuration.

FIG. 2 provides a detail view of an embodiment of the multifunctional membrane complex of the solid oxide-supercritical water electrochemical cell of FIG. 1.

FIG. 3 provides a sectional view of an embodiment of the solid oxide-supercritical water electrochemical cell in a micro tubular configuration.

### DESCRIPTION OF THE PREFERRED EMBODIMENTS

This disclosure is intended to teach by way of example and not by way of limitation.

Disclosed herein is a solid oxide electrochemical cell which uses as fuel carbonaceous materials, such as sewage or waste food, in a mixture with a fluid that is not a gas as is commonly understood by that term, and which has the capacity to transform sewage and waste food from a biohazard into a viable, non-polluting, domestic renewable energy source. In one embodiment, the stand-along device disclosed herein generally conjoins two previously unrelated processes to create a device that is capable of using the combustion of biomass, such as sewage, waste food or other suitable liquid or solid carbonaceous material, to generate heat, electricity and potable water. Stated differently, the stand-alone device disclosed herein combines a solid oxide electrochemical cell with a near-critical or supercritical water reactor. For the purposes of this application, this stand-alone device will hereinafter be referred to as the solid oxide supercritical water electrochemical cell (the “SOSWEC”). Generally, the SOSWEC disclosed herein can simultaneously generate two or more forms of energy with unprecedented efficiency by means of the combustion of oxidizable carbonaceous material in whole or in part by electrochemical oxidation under hydrothermal conditions.

The two processes conjoined in the SOSWEC are generally: (1) the oxidation (combustion) of any oxidizable material, notably hydrogen or compounds that contain a high proportion of hydrogen, or carbon or carbon containing materials that contain carbon and hydrogen, carbon and oxygen, or carbon, hydrogen and oxygen, and that may also contain other chemical elements such as but not limited to nitrogen, sulfur, phosphorous, and metal ions, notably but not limited to biomass, such as sewage solids or waste food, in near-critical or supercritical water; and (2) selective translocation of one or more than one specific reactive oxidant through a multifunctional membrane complex (MMC).

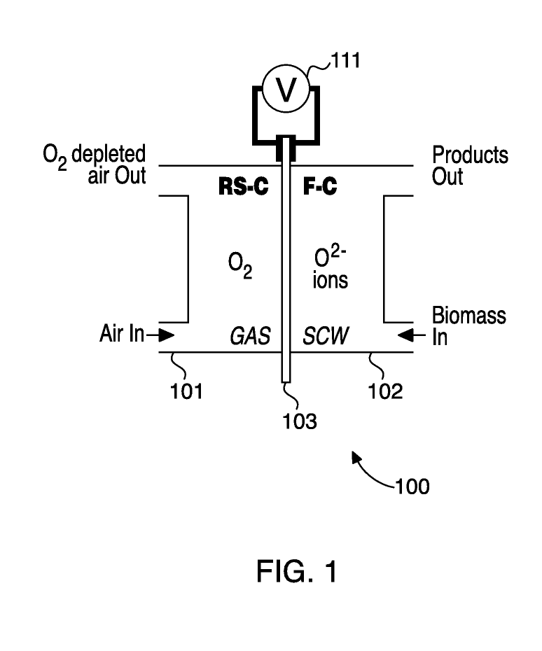

In one embodiment, as depicted in FIG. 1, the SOSWEC (100) is comprised of a first (101) and second (102) chamber separated by an MMC (103). It is contemplated that the first chamber (101), the reactive species chamber, comprises a chamber that contains an oxidant known to those of ordinary skill in the art. In one embodiment, the oxidant in the first chamber (101) will comprise a gas at or near its normal atmospheric pressure from which oxygen ions (O²⁻) can be generated through a reduction reaction. In one embodiment, this gas will be air. In another embodiment, this gas will be oxygen (O₂). Generally, as depicted in FIG. 1, it is contemplated that the reactive species chamber (101) will have an intake portal and an outtake portal to allow for the influx of the oxidant or material from which the oxidant can be separated or generated into the chamber and the outflux of used material from the chamber.

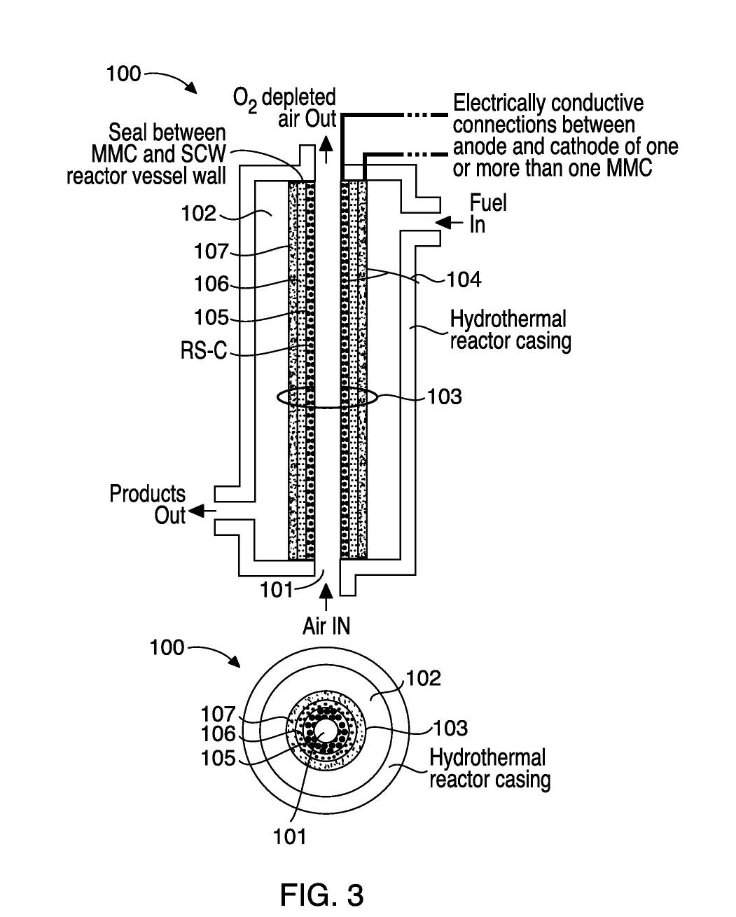

The second chamber, the fuel chamber (102), comprises a chamber that contains any oxidizable material, notably hydrogen or compounds, that contain a high proportion of hydrogen, or carbon or carbon containing materials that contain carbon and hydrogen, carbon and oxygen, or carbon hydrogen and oxygen, and that may also contain other chemical elements, such as but not limited to, nitrogen, sulfur, phosphorous and metal ions that is dissolved or suspended in near-critical or supercritical fluid, notably water. In one embodiment, the oxidizable material will comprise a biomass fuel source such as human fecal matter or sewage solids. Generally, the oxidizable carbonaceous material in the supercritical fluid in the fuel chamber (102) will be at a pressure, either constant or variable, that is equal to or less than about 80 megapascals (MPa) and at a temperature, either constant or variable, that is equal to or less than about 800° C. In one embodiment, the fuel chamber (102) will have an internal pressure that is more than about 22 MPa and a temperature that is more than about 374° C. Generally, the SOSWEC (100) comprises a combination of a solid oxide electrochemical cell known to those of ordinary skill in the art and a supercritical water reactor vessel known to those of ordinary skill in the art. In one preferred embodiment of the SOSWEC (100), depicted in FIG. 3, the supercritical water reactor becomes the fuel chamber (102) and the solid oxide electrochemical cell MMC (103) will be oriented in a manner such that it is sealed inside the supercritical water reactor vessel. No matter the orientation of the MMC (103) and the supercritical water reactor in the embodiment, it is contemplated that the fuel chamber (102) will have an intake portal for the intake of fuel and an outtake portal for the products of the reaction, such as repurified water, carbon dioxide, and nitrogen gas, to be removed from the device (100).

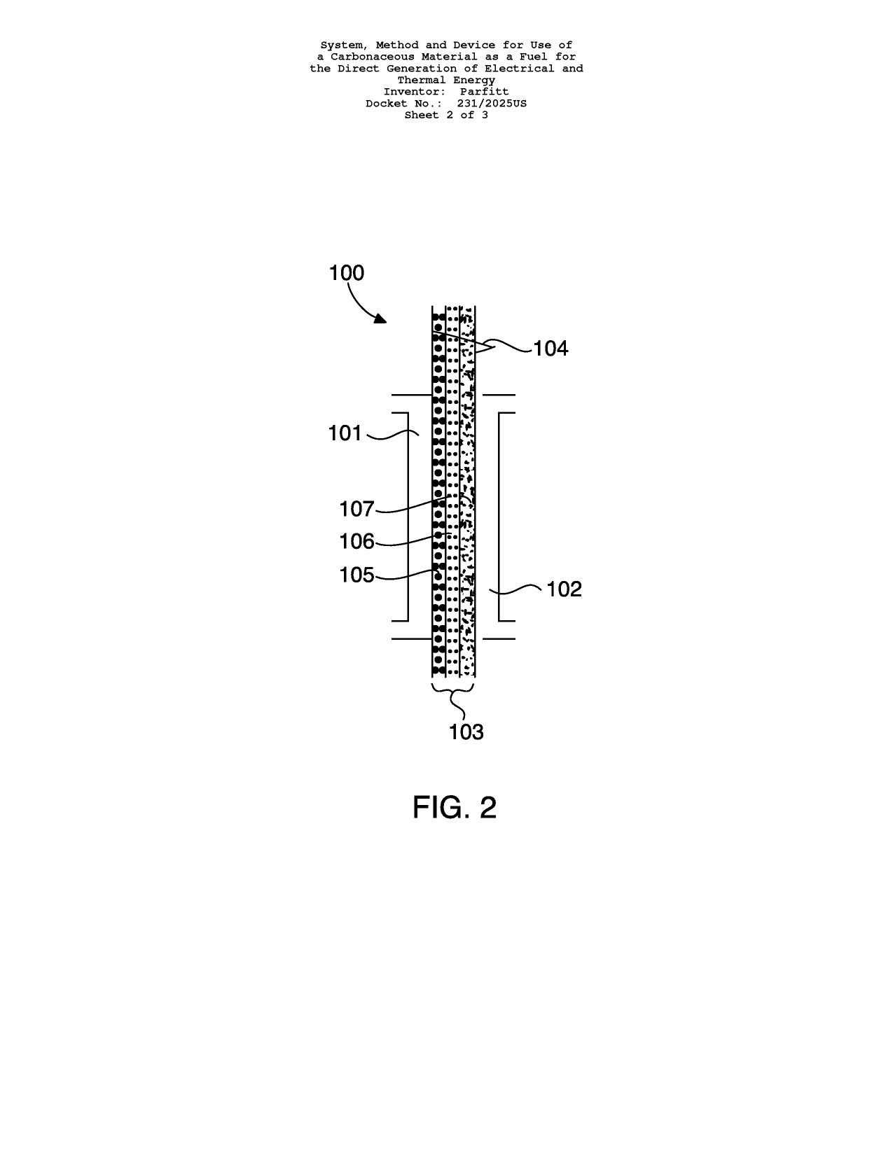

Generally, the MMC (103) of the SOSWEC (100), as demonstrated in FIG. 2, comprises a combination of functions: 1) a means for collecting and conducting electrons such as an electron conductor (104); 2) a means typically known as a cathode (105) for catalyzing the generation of oxygen ions from oxidants such as oxygen gas; 3) a means typically known as an electrolyte (106) for effecting the translocation of oxygen ions from the reactive species chamber (101) to the fuel chamber (102) by some means other than diffusion through pores that are contiguous through the membrane and through which translocation of chemical species is determined solely on the basis of molecular size such as, but not limited to, ionic movement through the atomic structure of the body of a crystal, or through the structure within or adjacent to the non-porous grain boundaries between such crystals and which may or may not incorporate features or atomic or molecular structures that are not present in the body of the crystal, or through the body of a monolayer or a multi-layer two-dimensional macromolecular leaflet such as graphene, or through the non-porous interfaces between the layers of such a multi-layer two-dimensional macromolecular leaflet; and 4) a means typically known as an anode (107) for creating a conjunction of oxidizable fuel in the supercritical fluid, the oxidant ions as they emerge from the electrolyte and electron collector. In one embodiment, the MMC is comprised of an oxygen ion conducting dense ceramic membrane known to those of ordinary skill in the art for use in solid oxide electrochemical cells. For example, in one embodiment, the oxygen ion conducting dense ceramic membrane will comprise a dense ceramic electrolyte (106) known to those of ordinary skill in the art sandwiched between a cathode (105) and an anode (107) oriented in a manner such that the anode (107) interfaces with the fuel chamber (102) and the cathode (105) interfaces with the reactive species chamber (101).

Generally, the properties of the medium to which the MMC (103) is exposed and the performance requirements of the SOSWEC (100) will drive the material selection for its component parts. For example, the reactivity and interdiffusion between the components, in some embodiments, will be as low as possible. Further, the thermal expansion coefficients of the components in one embodiment, will generally be as close to one another as possible in order to minimize the mechanical stresses of the system which could lead to cracking and mechanical failure. Also, the air side of the cell, in one embodiment, generally will operate in an oxidizing atmosphere and the fuel side generally will operate in an atmosphere that varies from oxidizing to reducing. These temperature and atmospheric considerations and other considerations, such as resistance to chemical poisoning, will drive the materials selection for the components of the SOSWEC (100).

For example, the cathode (105) of the SOSWEC (100) must meet the relevant temperature and atmospheric requirements in addition to being conductive to oxygen ions which must be able to travel through it and reach the anode/electrolyte interface. Further, in the tubular orientation, the cathode (105), the electrolyte (106) or the combination of the cathode (105) and electrolyte (106) provides sufficient structural support for the SOSWEC (100). Contemplated materials for the cathode (105) include any material known to those of ordinary skill in the art to have these properties including, but not limited to, lanthanum manganite, lanthanum ferrite, lanthanum coboltite, or other p-type semiconducting perovskite materials known to those of ordinary skill in the art. Further, it is contemplated that these materials may or may not be doped with rare earth elements such as cerium or strontium.

Further, because the oxygen ions generally migrate through the electrolyte (106) to the anode (107), the materials which comprise the electrolyte (106), in one embodiment, will ideally possess a high ionic conductivity and no electrical conductivity. It also may be fully dense to prevent short circuiting of the reacting gases through it. Moreover, as with the other materials in the SOSWEC (100), in one embodiment it will generally be chemically, thermally and structurally stable across a wide temperature range. Accordingly, any electrolyte material (106) known to those of ordinary skill in the art that has these properties, such as doped cerium oxide and doped yttrium oxide, are contemplated.

The anode (107) will generally meet the same considerations of the cathode (105) for electrical conductivity, thermal expansion compatibility and porosity in addition to functioning in both a reducing and an oxidizing (redox) atmosphere. In sum, it generally will have both the required electrical conductivity considerations and redox stability. Any material known to those of ordinary skill in the art that has these properties, such as but not limited to, Ni-YSZ composite and Cu-cerium oxide, are contemplated.

Finally, the current electron conductors (104) of the SOSWEC (100) must also be conductive and have thermal expansion compatibility and inertness with respect to the other components. Contemplated current conductors include materials known to those of ordinary skill in the art which have these properties and are able to conduct and collect electrons such as, but not limited to: inert metals; mixed or electronically conducting metal oxides, such as LaCrO3 doped with a rare earth element; and nickel or the interface or grain boundary between suitable materials which when not conjoined may behave as electrical insulators.

In one embodiment, the SOSWEC (100) will be configured in a planar orientation as depicted in FIG. 1. In this design embodiment, the component layers of the MMC (103) are generally assembled in flat stacks between the fuel chamber (102) and the reactive species chamber (101). In this planar embodiment, as depicted in FIGS. 1 and 2, the cathode (105) is in intimate contact with the oxidant in the reactive species chamber (101); the electrolyte (106) is sandwiched between the cathode (105) and the anode (107); and the anode (107) is located in intimate contact with the fuel chamber (102).

In another preferred embodiment, the SOSWEC (100) will be configured in a tubular orientation as depicted in FIG. 3. In this orientation, the component layers of the SOSWEC (100) are arranged in the form of a hollow tube, with the components constructed in concentric layers around a central tubular cathode (105). In this embodiment, the reactive species chamber (101) comprises the longitudinal cylindrical channel through the center of the tubular SOSWEC (100). The oxidant flows into this cylindrical channel reactive species chamber (101) at one end and the depleted air flows out of this cylindrical channel reactive species chamber (101) at the other end. In one embodiment, the cylindrical channel reactive species chamber is filled with a porous, mechanically resilient, gas-permeable material known to those of ordinary skill in the art that provides the structural support necessary to prevent collapse of the MMC (103) under the large pressure differential that exists between the fuel chamber (102) and the reactive species chamber (101). In another embodiment, it is contemplated that the central channel will also include a heating element for the fast start-up of the SOSWEC (100). Generally, any suitable heating element know to those of ordinary skill in the art for heating up the reaction in a solid oxide fuel cell is contemplated for the heating element of the SOSWEC (100). In another embodiment, it is further contemplated that the central channel may also contain a second tubular solid oxide fuel cell and that the cathode of the second solid oxide fuel cell will share the same reactive species chamber as the enclosing solid oxide fuel cell and that the second solid oxide fuel cell may use a gaseous fuel.

As shown in FIG. 3, located next to the central chamber that comprises the reactive species chamber (101) in the tubular orientation of the SOSWEC (100) is the MMC (103). It is contemplated that in one embodiment of the SOSWEC (100) in which it is in micro tubular form, the cathode (105) lines the longitudinal cylindrical channel through the center of the SOSWEC (100) that constitutes the reactive species chamber (101). Also in this micro tubular embodiment, it is contemplated that this cathode layer (105) also includes a current conductor (104). In addition to being in intimate contact with the reactive species chamber (101), in this orientation the cathode layer tube (105) will also be in intimate contact with the concave surface of a cylindrical layer of electrolyte (106) or with an intermediate layer which serves to enhance the functionality of the contact between the cathode and electrolyte. Further, the convex surface of the cylindrical layer of electrolyte (106) will be in intimate contact with a tubular anode layer (107) or with an intermediate layer which serves to enhance the functionality of the contact between the electrolyte and the anode, this anode layer (107) also containing a current conductor (104). In sum, in the tubular orientation of the preferred embodiment, the cathode (105) forms the smallest center tube that defines the reactive species chamber (102) and the anode (107) forms the outmost exterior tube which is located within the fuel chamber (102). The cylindrical layer of electrolyte (106) will be located between the anode layer (107) and the cathode layer (105).

Generally, the translocation of reactive oxidant through the MMC (103) occurs in a manner similar to how this process occurs in the solid oxide fuel cells known to those of ordinary skill in the art. In simple terms, an oxidant, such as oxygen in air, comes into contact with the cathode (105) of the MMC (103). When the oxidant contacts the cathode (105) it catalytically acquires electrons from the cathode and negatively charged ions of the oxidant are created. In the embodiment in which the oxidant is oxygen gas, the oxygen acquires four electrons and splits into two oxygen ions. Next, the oxygen ions enter the electrolyte material (106) and migrate to the other side of the cell where they encounter the anode (107). When the oxygen ions reach the surface of the anode (107) that is in contact with the supercritical water, they react directly with the fuel or the decomposition products of the fuel to produce water, carbon dioxide, heat and electrons, or with each other to produce electrons and oxygen gas which then reacts with the fuel or the decomposition products of the fuel to produce water, carbon dioxide and heat. The released electrons are collected and conducted through an external electrical circuit (111) back to the cathode (105), providing a source of electrical power and a source of electrons for the continued cathode-catalyzed reduction of oxidant as would be understood by one of ordinary skill in the art. Generally, the electrical power generated is proportional to the Gibbs free energy released by the reactions that occur in the fuel chamber that result in the release of electrons that can be captured and returned to the cathode.

In order for the SOSWEC (100) to efficiently produce oxygen ions and translocate oxygen ions through the MMC (103), two conditions must occur: 1) the MMC (103) must be at a temperature high enough to allow the oxygen ions to permeate and move within it; and 2) the concentration of oxygen ions in the reactive species chamber (101) must be greater than its concentration in the fuel chamber (102). Generally, the oxygen gradient across the MMC (103) determines the direction of the oxygen ion flux in addition to the magnitude of the flux up to its maximum value, which is determined by other factors, such as, the rate of production of oxygen ions at the cathode and the material composition of the electrolyte. Since the combustion of the fuel generally consumes all of the oxygen as soon as it leaves the MMC (103), the oxygen concentration in the fuel chamber (102) will remain close to zero for as long as fuel is available.

In a traditional solid oxide fuel cell, a carbonaceous fuel, such as a hydrocarbon gas like methane or propane, must first be broken down into hydrogen and carbon monoxide gasses by a process called fuel reforming. The combustion of hydrogen and carbon monoxide exploits the natural tendency of oxygen ions to react with these gases in the process of electrochemical oxidation at the anode (107) and the capture of all or part of the energy released by this reaction enables the solid oxide fuel cell to generate electrical power. In the SOSWEC, fuel reforming is expected to occur rapidly and spontaneously at the anode (107) since it is well known that the mixture of hydrocarbon oils and free carbon generated from biomass by supercritical water treatment alone is rapidly mineralized following introduction of oxygen. In general, combustion, as that term is used in the art, is the term for the heat producing exothermic chemical reactions that occur when reactants, usually consisting of fuel plus an oxidant such as oxygen, are mixed and heated to a temperature at which spontaneous ignition occurs. Thus, State A of the combustion reaction is comprised of the reactants (fuel and oxygen) plus heat and State B of the combustion reaction is comprised of the products of the combustion reaction plus energy in the form of heat and light. The net change in the sum of the energies of all the materials that exist in the entire system (i.e., State A+State B) during the combustion reaction is generally known as Gibbs energy, and is an indication of the amount of work that can be performed as a result of the combustion, for example, the amount of power available in an electrical circuit. Once the combustion process is underway, it usually generates enough excess heat to keep the reactants above the temperature of spontaneous ignition. At this time, the reaction becomes “autothermal.”

In general, in a solid oxide fuel cell combustion takes place under stringent conditions that define the spatial organization of the reaction site, the state of the reactants and the disposition of the products required for the generation of power. Thus, the method and rate of delivery of both fuel and oxidant into the fuel chamber can be controlled. Within the solid oxide fuel cell, the energy from the combustion is not used to drive a heat engine electrical generator such as a reciprocating piston or a rotary turbine type. Instead, the energy from the combustion is used without the interposition of a separate ‘heat engine,’ to directly create a flow of electrons (the electric current) between a cathode an anode. Generally, the efficiency of the conversion of fuel into electricity by this method can reach 60% or more. By controlling the rate of delivery of the reactants and the means by which the combustion reaction occurs, the solid oxide fuel cell is able to harvest the energy given off by the reaction.

Within the SOSWEC (100), combustion thus plays generally three (3) roles. First, it creates and maintains the oxygen ion gradient across the MMC (103) that drives the oxygen ion flux which is obligatorily coupled to the counterflow of electrons that constitutes the electric current. Second, it generates the thermal energy required to heat the MMC (103) and reform the fuel. Third, it captures the Gibbs energy that determines the power available at the electrical circuit.

Traditionally in the art, under normal atmospheric conditions, biomass combustion reactions must use relatively dry biomass to be flammable. For example, wet fuel must be dried before burning which can consume a great deal of energy and the wetter the fuel, the more energy that is required and consumed to dry it. In some instances, eventually a point is reached at which the energy consumed by the drying exceeds the energy that is generated by the combustion. At this point, the reaction ceases to be autothermal and combustion can only be sustained by input of additional energy from an external source. This excess energy, which is required for drying sewage solids or other biomass sources such as waste food prior to combustion, can consume as much or more energy than can be recovered from their subsequent combustion. Accordingly, wet carbonaceous materials such as fecal matter and food waste have not been traditionally used directly, and without drying as fuel sources in solid oxide fuel cells or in any other energy conversion devices, rather, they have typically been treated in some way to produce hydrogen and carbon monoxide gasses which then serve as the fuel for an energy conversion device such as a solid oxide fuel cell.

Wet fuels such as fecal sludge and food waste can, however, be efficiently burned in the SOSWEC (100) through a process that is entirely, or in part, electrochemical oxidation which takes place at the anode (107) of the MMC (103) in the supercritical water in the fuel chamber (102). Generally, a supercritical fluid is a substance at a temperature and pressure above its critical point, where distinct liquid and gas phases do not exist. Thus, in general terms, a supercritical fluid is in a distinct phase-state of matter that is nether liquid nor gas, but that can exhibit certain properties that are commonly associated with each. In addition, close to the critical point, small changes in pressure or temperature result in large changes in several physical properties such as density and specific heat allowing many properties of a supercritical fluid to be “fine-tuned.” Accordingly, supercritical water is generally a form of water that exists only under a pressure that is more than 217 times normal atmospheric pressure and at temperatures of generally more than 374 degrees Celsius. As the pressure and temperature increase, so does the speed and efficiency of the combustion of carbonaceous material that is dissolved in supercritical water, provided that water contains a sufficiency of oxygen. For example, at 25 MPa and 600 degrees Celsius a combustion is more than 99.999% complete in less than 60 seconds. This is a performance that is likely to be further improved by the process intensification that occurs in a micro-channel reactor.

Generally, any method for the creation of supercritical water is contemplated as the supercritical water component of the fuel chamber (102) of this application. For exemplary purposes, in one embodiment it is contemplated that the supercritical water will be created in the following manner. First, prior to entering the supercritical water reactor, the input water containing the carbonaceous material will be pressurized. Any mineral salts present in the carbonaceous material feedstock will be removed before the input water is pressurized. In a next step, the hydrogen and carbon monoxide derived from fuel reforming combine with the oxygen ions at the surface of the anode to form water and carbon dioxide, respectively. Any organic matter present in the water is thus fully oxidized. In one embodiment, thermal energy may be added to the reactor to maintain its temperature inside the supercritical water region. Generally, the output effluent water will then pass into a work and heat exchanger of a type known to those of ordinary skill in the art where energy is transferred from the reactor output to the reactor input. Next, the output effluent water is condensed to allow for water capture while other gases present in the stream may be vented or otherwise removed.

In sum, the hydrothermal oxidation that occurs in the supercritical water reactor is one of the most useful energy conversion technologies for wet biomasses, such as fecal matter. The supercritical water reactor also has certain additional properties that make it an especially versatile and attractive medium for presenting fuel to the solid oxide fuel cell anode in the SOSWEC (100). These attributes include its very low surface tension, which means that it can easily flow through the micro pores in the anode. It also has the ability to dissolve many gases, liquids and biomaterials that are insoluble in liquid water. Further, it also becomes autothermal when the amount of fuel reaches a mere 5% of the amount of water present. Finally, almost no nitrous oxide is generated because the reaction temperature remains below 1,500 degrees Celsius.

In function, the SOSWEC (100) has generally four (4) effects. First, the SOSWEC (100) generally results in complete oxidative destruction, also known as mineralization, of the biomass (such as sewage solids) in the fuel chamber (102) by oxidation in the supercritical water reactor. Second, the SOSWEC (100) generally results in repurification of waste water. Third, the SOSWEC (100) generally results in an energy-efficient transfer of oxygen from the air at normal atmospheric pressure, without either preliminary purification or mechanical pressurization, into the high pressure medium inside the fuel chamber (102). Fourth, the SOSWEC (100) generally results in the generation of electrical energy. Finally, the SOSWEC (100) generally results in the generation of thermal energy.

It is contemplated that one or more SOSWECs can be combined to create a compact, autonomous and secure micro-sanitation and water repurification system (a Sewage Containment and Mineralization device (SeCoM)). Some of the benefits of a SeCoM comprised of one or more SOSWECs (100) over sanitation devices known in the art are numerous. First, the SOSWEC (100) enables the development of compact, autonomous and secure micro-sanitation and water repurification systems, i.e., SeCoMs, that may make it possible to create autonomous toilets that need no external plumbing or additional power input of any type and that do not discharge any solid or liquid material, but only discharge greenhouse-neutral volumes of carbon dioxide and nitrogen that: do not cause a net increase in their concentration in the atmosphere; that are suitable for installation in individual residences; or can be used as stand-alone public facilities of any type. Examples of contemplated facilities include, but are not limited to, static, portable and mobile facilities. Further, these SeCoMs are suitable for installation at generally any location, including but not limited to, terrestrial and aquatic locations. Next, the SeCoMs eliminate dependence on utility infrastructure for the provision of water and sanitation removal services for a community. This advancement mitigates the stress imposed on utility infrastructure by new development and moderates the cost of renovating water and sewerage delivery networks by phased development of the SeCoM into existing network-connected homes.

Another advantage of the SeCoM is its near-zero environmental footprint. Stated differently, the SeCoM has the capacity to mineralize biomass and re-purify water without discharging anything except greenhouse neutral amounts of carbon dioxide and nitrogen. This advantage of the SeCoM makes it available for development of land that is currently considered unsuitable or uneconomic. Notably, roughly 75% of the privately-owned land in the United States falls under this category. Amongst other things, this advantage of the SeCoM will reduce the competition between property developers and farmers for the use of available prime farm land. This advantage of the SeCoM also generally eliminates the threat of environmental contamination by pathogenic organisms that leak from conventional on-site sanitation systems. This advantage of the SeCoM has the capacity to rescue older properties with on-site sanitation systems that cannot be upgraded to meet contemporary standards.

Yet another advantage of the SeCoM is its simplicity. Generally, it has no moving parts and, as such, requires only infrequent, minimal maintenance. Notably, the neglect of maintenance is one of the principal causes of failure in the on-site sanitation and water purification systems currently utilized in the art.

Another advantage of the SeCoM is its speed and efficiency. Because the SeCoM is configured as a microchannel reactor, the SeCoM benefits from the enhanced speed and efficiency (i.e., process intensification) of chemical reactions that result from system miniaturization.

The SeCoM also has a beneficial effect because of its ability to rapidly regenerate potable water from wastewater. Thus, losses in water can be automatically replenished from “virtual water” in foods. Since a fixed volume of water is being continuously recycled, the stringent water conservation within the home that was often required with other prior art systems will no longer be necessary.

Also, because it does not utilize microbial processing, as many of the systems of the prior art, the SeCoM ensures complete destruction of all organic contaminants and enables shut down and restart without damage. It also is unaffected by biological poisons, toxins and mutagens and it will not contaminate the local microbial ecosystem in the event of a containment failure.

Finally, because the SeCoM can mineralize a variety of biomass types, it opens the door to enabling the efficient intra-residential generation of energy from any suitable carbonaceous material, including sewage and other forms of domestic trash.

Outside of enabling the development of SeCoM systems, the SOSWEC disclosed in this application enables the development of small combined heat and power units. These units can burn a wide variety of fuels such as biomass, liquid and gaseous hydrocarbons or pulverized coal. Further, these units would be suitable for individual homes and could serve as an alternative to the internal combustion engine.

In operation, the SOSWEC would often be used as a self-contained septic system. This can be for a small or large community or a single household or building. Generally, the SOSWEC would be provided to the location and connected to sewage lines. These can be traditional water lines, or could be part of a solid system (e.g. an outhouse or latrine). Sewage can be collected until it is sufficient to provide a batch. In larger communities the feed of collected sewage could be batch fed, continuous, or near continuous.

Once a sufficient batch is obtained, prior heated water would be used to heat the sewage component. This may be by flooding (e.g. if the sewage is mostly solid) and/or by heat transfer. Regardless of method, inorganic materials may be filtered and this extremely hot mixture will be provided to the reactive species chamber (101) and is then placed under pressure. Air flow through the fuel chamber (102) may have already commenced or may be initiated.

In the event that the batch is not supercritical or near supercritical temperature, heat may be added. Ion flow will commence across the MMC (103) resulting in oxidation of the components in the chamber (101) and the flow of electricity through wire (111). Once the reaction has completed, water, which is now clean, can be removed from the chamber (101). The water is preferably stored, maintaining as much heat as possible. However, whenever there is an excess of water, some water may be removed and chilled to be supplied as clean water to the community.

Electricity in wire (111) may be stored in any manner known to those of ordinary skill in the art and may also be provided by standard electrical distribution to the community, or may be maintained at the SOSWEC to be used to provide additional heat when a new batch of sewage is incoming. In this way, the system is relatively self-contained and requires little, if any, input of energy or clean water. In an embodiment, the system is energy neutral (using only energy it generates) and in another embodiment is energy positive (produces more energy than it uses).

Because of the desire to maintain the water that was processed in chamber (101) at a high heat, if the SOSWEC operates in a relatively slower batch mode, the SOSWEC housing may be insulated in an attempt to maintain the temperature of the water at a higher level for a longer time.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A solid oxide supercritical water electrochemical cell comprised of:
a reactive species chamber with an intake portal and an outtake portal, said reactive species chamber including an oxidant;
a fuel chamber with an intake portal and an outtake portal, said fuel chamber including an oxidizable material and supercritical water; and
a multifunctional membrane complex which separates said reactive species chamber from said fuel chamber, said multifunctional membrane complex being comprised of:
an electron conductor;
an electrolyte;
a cathode; and
an anode;
wherein, said oxidant contacts said cathode and produces oxygen ions which flow from said cathode, through said electrolyte, to said anode; and
wherein said oxygen ions reacting with said oxidizable material at said anode to produce free electrons.

2. The solid oxide supercritical water electrochemical cell of claim 1, wherein said oxidizable material is dissolved or suspended in said supercritical water.

3. The solid oxide supercritical water electrochemical cell of claim 1, wherein said oxidant in said reactive species chamber is a gas at or near its normal atmospheric pressure from which oxygen ions can be generated through a reduction reaction.

4. The solid oxide supercritical water electrochemical cell of claim 3, wherein said gas is air.

5. The solid oxide supercritical water electrochemical cell of claim 1, wherein said oxidant is oxygen.

6. The solid oxide supercritical water electrochemical cell of claim 1, wherein said oxidizable material is a biomass.

7. The solid oxide supercritical water electrochemical cell of claim 6, wherein said biomass is chosen from the group consisting of: human fecal matter and sewage solids.

8. The solid oxide supercritical water electrochemical cell of claim 1, wherein said oxidizable material is at a pressure that is equal to or less than about 80 MPa.

9. The solid oxide supercritical water electrochemical cell of claim 1, wherein said oxidizable material is at a temperature of equal to or less than about 800° C.

10. The solid oxide supercritical water electrochemical cell of claim 1, wherein said cathode is comprised of a material chosen from the group consisting of: lanthanum manganite, lanthanum ferrite and lanthanum coboltite.

11. The solid oxide supercritical water electrochemical cell of claim 1, wherein said electrolyte is comprised of a material chosen from the group consisting of: doped cerium oxide and doped yttrium oxide.

12. The solid oxide supercritical water electrochemical cell of claim 1, wherein said anode is comprised of a material chosen from the group consisting of: Ni-YSZ composite and CU-cerium oxide.

13. The solid oxide supercritical water electrochemical cell of claim 1, wherein said solid oxide supercritical water electrochemical cell is configured in a planar orientation.

14. The solid oxide supercritical water electrochemical cell of claim 1, wherein solid oxide supercritical water electrochemical cell is configured in a tubular orientation.

15. The solid oxide supercritical water electrochemical cell of claim 14, wherein:
said reactive species chamber comprises a longitudinal cylindrical channel defined by said multifunctional membrane complex, said multifunctional membrane complex comprising:
a cylindrical cathode layer;
a cylindrical electrolyte layer; and
a cylindrical anode layer;
wherein said cylindrical cathode layer is in intimate contact with said cylindrical reactive species chamber;
wherein said cylindrical electrolyte layer is located between said cylindrical cathode layer and said cylindrical anode layer; and
said reactive species chamber and said multifunctional membrane complex are located within said fuel chamber.

16. The solid oxide supercritical water electrochemical cell of claim 15, wherein said oxidant flows into said cylindrical reactive species chamber at one end and said depleted air flows out of said cylindrical reactive species chamber at said other end.

17. The solid oxide supercritical water electrochemical cell of claim 16, wherein said cylindrical reactive species chamber includes a heating element.

18. A method for purifying water, said method comprising:
providing a solid oxide supercritical water electrochemical cell including:
a reactive species chamber with an intake portal and an outtake portal;
a fuel chamber with an intake portal and an outtake portal; and
a multifunctional membrane complex which separates said reactive species chamber from said fuel chamber, said multifunctional membrane complex being comprised of:
an electron conductor;
an electrolyte;
a cathode; and
an anode;
feeding air into said reactive species chamber via said intake portal;
feeding an oxidizable material and water into said fuel chamber;
raising said water in said fuel chamber to supercritical temperature and pressure;
allowing oxygen ions to flow from said reactive species chamber, through said multifunctional membrane complex, to said fuel chamber;
allowing said oxygen ions to react with said oxidizable material generating free electrons;
capturing said free electrons with said electron conductor; and
removing clean water from said fuel chamber.

19. The method of claim 18, wherein said oxidizable material is a biomass.

20. The method of claim 19, wherein said biomass is chosen from said group consisting of:
human fecal matter and sewage solids.
